(19) United States
(12) Patent Application Publication
(10) Pub. No.: US 2017/0106637 A1
(43) Pub. Date: Apr. 20, 2017

(54) OPTICAL FILM, POLARIZING PLATE, AND IMAGE DISPLAY DEVICE

(71) Applicant: FUJIFILM Corporation, Tokyo (JP)

(72) Inventors: Takayasu YAMAZAKI, Kanagawa (JP); Shuntaro IBUKI, Kanagawa (JP); Miho ASAHI, Kanagawa (JP); Makoto KAMO, Kanagawa (JP)

(73) Assignee: FUJIFILM Corporation, Tokyo (JP)

(21) Appl. No.: 15/392,415

(22) Filed: Dec. 28, 2016

Related U.S. Application Data
(63) Continuation of application No. PCT/JP2015/068519, filed on Jun. 26, 2015.

(30) Foreign Application Priority Data
Jun. 30, 2014 (JP) 2014-135212

(51) Int. Cl. B32B 27/36; G02B 5/30; G02F 1/1335; G02B 1/14

(52) U.S. Cl. CPC B32B 27/36; G02B 1/14; G02B 5/3025; G02F 1/133528; B32B 2307/42; B32B 2307/536; B32B 2457/20

(57) ABSTRACT

An aspect of the invention relates to an optical film including a cellulose acylate film; and a hardened layer formed by hardening a curable composition, in which the cellulose acylate film includes polyester having a cyclic structure, the curable composition at least includes a granular filler, a polyester urethane having a tensile strength of 25 MPa or greater and a tensile elongation of 200% or greater, and a curable compound, and a content of the granular filler is in a range of 15 to 60 parts by mass and a content of the polyester urethane is in a range of 1 to 10 parts by mass, with respect to 100 parts by mass of a total amount of a solid content included in the curable composition, a polarizing plate, and an image display device.

### CROSS-REFERENCE TO RELATED APPLICATIONS

This application is a Continuation of PCT International Application No. PCT/JP2015/068519 filed on Jun. 26, 2015, which claims priority under 35 U.S.C §119(a) to Japanese Patent Application No. 2014-135212 filed on Jun. 30, 2014. Each of the above applications is hereby expressly incorporated by reference, in its entirety.

### BACKGROUND OF THE INVENTION

1. Field of the Invention

The present invention relates to an optical film, a polarizing plate, and an image display device.

2. Description of the Related Art

As a protective film provided on a surface of an image display device represented by a liquid crystal display (LCD), a plasma display panel (PDP), an electro-luminescence display (ELD), or the like, an optical film (laminated film) obtained by laminating a hard coat layer on a substrate film is widely used (for example, JP2005-288787A and JP2010-102123A).

The optical film included in the image display device is desired to have high transparency, in order not to decrease visibility of an image. For example, in a case where a protective film obtained by laminating a hard coat layer is applied to an LCD, since the protective film is generally disposed on the outer side of a visible side polarizer, the optical film used as the protective film is required to have high transparency in order not to decrease visibility of the LCD.

### SUMMARY OF THE INVENTION

The optical film is required to have high hardness in order to improve durability and scratch resistance of the image display device. Examples of means for causing the optical film to have high hardness include increasing hardness of the hard coat layer. However, if only the hardness of the hard coat layer is increased, the hard coat layer becomes brittle (deterioration of brittleness), and as a result, cracks are generated at the time of bending the optical film, and thus transparency decreases.

Meanwhile, as disclosed in JP2005-288787A and JP2010-102123A, the addition of a granular filler such as metal oxide particles to the hard coat layer is effective for causing the hard coat layer to have high hardness. However, in a hard coat layer including a granular filler, haze (cloudiness) is generated due to the aggregation of the granular filler or the fall of particles in a chemical treatment (for example, saponification) of a manufacturing step. If haze is generated in the hard coat layer, it becomes difficult to obtain an optical film having excellent transparency.

As described above, it is difficult to cause an optical film to have high hardness, while suppressing the decrease of transparency of an optical film, and specifically, to obtain an optical film having high hardness while improvement of brittleness of the hard coat layer and suppression of haze are achieved.

Here, an object of the invention is to provide an optical film in which decrease of transparency is suppressed, and hardness is high.

The present inventors diligently conducted research, and as a result, newly found an optical film below: an optical film comprising a cellulose acylate film; and a hardened layer formed by hardening a curable composition, in which the cellulose acylate film includes polyester having a cyclic structure, the curable composition at least includes a granular filler, polyester urethane having a tensile strength of 25 MPa or greater and a tensile elongation of 200% or greater, and a curable compound, and a content of the granular filler is in a range of 15 to 60 parts by mass and a content of the polyester urethane is in a range of 1 to 10 parts by mass, with respect to 100 parts by mass of a total amount of a solid content included in the curable composition.

Hereinafter, these are described below. However, the followings are assumptions of the present inventors, and do not limit the invention at all.

In the optical film obtained by laminating the hard coat layer on the substrate film, it is required that both of the substrate film and the hard coat layer have high hardness and high transparency.

With respect to the substrate film, a cellulose acylate film represented by cellulose acetate has high transparency and is appropriate for a substrate film of an optical film. Therefore, the present inventors employ a cellulose acylate film, as a substrate film of an optical film. The present inventors conducted research on high hardness of the cellulose acylate film and found that hardness of the cellulose acylate film is improved by adding polyester including a cyclic structure to a cellulose acylate film. The present inventors considered that hardness was improved by introducing polyester having a cyclic structure to a free volume portion of cellulose.

With respect to the hard coat layer, in view of easiness of formation of a film and hardness, the hard coat layer is formed as a hardened layer formed by hardening a curable composition at least including a curable compound. The present inventors further conducted research, and as a result, newly found that, if a curable composition including a granular filler and polyester urethane exhibiting the tensile strength and a tensile elongation described above in proportions described above is used at the time of forming the hardened layer, it is possible to suppress the deterioration of brittleness and the increase of haze, while high hardness is achieved. The present inventors assume that main reasons of this are, if polyester urethane showing a tensile strength and a tensile elongation described above is included in the hard coat layer in the proportions above, polyester urethane contributes to making the hard coat layer have high hardness and appropriate flexibility and making polyester urethane have high affinity with the granular filler and can suppress aggregation of the granular filler and falling or elution of the granular filler due to the chemical treatment in the manufacturing step.

According to an aspect, polyester included in the cellulose acylate film at least includes a repeating unit derived from polyvalent carboxylic acid and a repeating unit derived from a polyol. The repeating unit derived from polyvalent carboxylic acid at least includes a repeating unit derived from polyvalent carboxylic acid having a cyclic structure.

According to an aspect, the repeating unit derived from polyvalent carboxylic acid having a cyclic structure is a repeating unit derived from aromatic polyvalent carboxylic acid.

According to an aspect, the repeating unit derived from polyvalent carboxylic acid can include a repeating unit derived from aliphatic polyvalent carboxylic acid, and when the number of repeating units derived from aliphatic polyvalent carboxylic acid included in the polyester is m, and the number of repeating units derived from aromatic polyvalent carboxylic acid is n, a ratio m:n between m and n is in a range of 0:10 to 3:7.

According to an aspect, a film thickness of the cellulose acylate film is in a range of 15 to 40 μm.

According to an aspect, the granular filler is a granular filler having a reactive group on an inorganic particle surface.

According to an aspect, the reactive group is a polymerizable unsaturated group.

According to an aspect, the curable compound includes a compound having a (meth)acryloyl group.

According to an aspect, the optical film further comprises a layer having a refractive index lower than that of the hardened layer.

According to an aspect, a Knoop hardness measured on a surface on a side having the hardened layer of the optical film is 280 N/mm² or greater. According to the invention, the Knoop hardness is a value measured by a method regulated in JIS Z 2251:1998.

Another aspect of the invention relates to a polarizing plate comprising the optical film and a polarizer.

Another aspect of the invention relates to an image display device comprising the optical film.

According to an aspect, the image display device comprises the polarizing plate, in which the polarizing plate includes the optical film.

According to an aspect, the image display device has the polarizing plate at least on a visible side.

According to the invention, it is possible to provide an optical film having a cellulose acylate film and a hardened layer (hard coat layer), in which high hardness is realized while the decrease of transparency is suppressed. If this optical film is used as a protective film of a polarizer, it is possible to provide a polarizing plate having high durability and a liquid crystal display device including this polarizing plate.

Falling or elution of components from the film in the manufacturing step causes the number of times of washing of manufacturing facilities to increase, and thus the falling or the elution is not desirable in view of productivity improvement. In this point of view, according to the invention, it is possible to prevent falling or elution of the granular filler added to the hardened layer (hard coat layer) in the manufacturing step in order to cause the optical film to have high hardness. Therefore, according to this, it is possible to improve productivity.

### DESCRIPTION OF THE PREFERRED EMBODIMENTS

The description below is made based on the representative embodiment of the invention. However, the invention is not limited thereto, and numerical values indicated by using the expression “to” in the invention and this specification mean a range including numerical values indicated before and after the expression “to” as a lower limit value and an upper limit value. According to the invention and the specification, unless described otherwise, groups described may have a substituent or may not be substituted. Examples of a substituent in a case where a certain group has a substituent include an alkyl group (for example, an alkyl group having 1 to 6 carbon atoms), a hydroxyl group, an alkoxy group (for example, an alkoxy group having 1 to 6 carbon atoms), a halogen atom (for example, a fluorine atom, a chlorine atom, and a bromine atom), a cyano group, an amino group, a nitro group, an acyl group, and a carboxyl group. The number of carbon atoms included in the group that has a substituent means the number of carbon (atoms) in a portion including a substituent.

[Optical Film]

The optical film according to an aspect of the invention includes a cellulose acylate film and a hardened layer formed by hardening a curable composition. The cellulose acylate film includes polyester having a cyclic structure and the curable composition at least includes a granular filler, polyester urethane having a tensile strength of 25 MPa or greater and a tensile elongation of 200% or greater, and a curable compound. A content of the granular filler is in a range of 15 to 60 parts by mass and a content of the polyester urethane is in a range of 1 to 10 parts by mass with respect to 100 parts by mass of a total amount of a solid content included in the curable composition.

Hereinafter, the optical film is described in greater detail.

<Cellulose Acylate Film>

(Cellulose Acylate)

The cellulose acylate film included in the optical film includes at least cellulose acylate and further includes polyester having a cyclic structure. Details of polyester are described. Cellulose acylate is preferably included as a main component of the cellulose acylate film. Here, the main component refers to a component that occupies the greatest portion among the components included in the film.

Cellulose acylate is not particularly limited. As details of a substituted acyl group of the hydroxyl group in cellulose acylate, paragraph 0017 of JP2012-215812A is exemplified. An acetyl group, a propionyl group, and a butanoyl group are preferable, an acetyl group and a propionyl group are more preferable, and an acetyl group is even more preferable. In view of compatibility with the polyester, cellulose acylate having an acetyl substitution degree of 2.7 or greater is preferable, cellulose acylate having an acetyl substitution degree of 2.75 or greater is more preferable, and cellulose acylate having an acetyl substitution degree of 2.82 or greater is even more preferable. Meanwhile, in view of optical performance, cellulose acylate having an acetyl substitution degree of 2.95 or less is preferable, cellulose acylate having an acetyl substitution degree of 2.90 or less is more preferable, and cellulose acylate having an acetyl substitution degree of 2.89 or less is even more preferable. In the same point of view, it is preferable that a total acyl substitution degree of cellulose acylate is also in the ranges with respect to the acetyl substitution degree. The total acyl substitution degree and the acetyl substitution degree can be measured in conformity with the method regulated in ASTM-D817-96. The portion that is not substituted with an acyl group generally exists as a hydroxyl group. Otherwise, as details of cellulose acylate, paragraphs 0018 to 0020 of JP2012-215812A can be exemplified.

(Polyester Having Cyclic Structure)

The cellulose acylate film includes polyester having a cyclic structure together with cellulose acylate. As described above, if polyester having a cyclic structure is introduced to a free volume portion of cellulose, the present inventors assume that hardness of the cellulose acylate film can be increased. The cyclic structure may be an aliphatic ring, an aromatic ring, a carbon ring, or a heterocyclic ring. In view of further improving hardness, an aromatic ring is preferable, and an aromatic carbon ring is more preferable. Examples of a preferable aromatic carbon ring include a benzene ring.

Polyester is a polycondensate of polyvalent carboxylic acid such as dicarboxylic acid and a polyol such as diol. Polyvalent carboxylic acid and a polyol that form polyester each may be only one type and or may be two or more types. Polyvalent carboxylic acid and a polyol are divalent or greater polyfunctional compounds. For example, polyvalent carboxylic acid and a polyol are divalent or trivalent compounds and preferably divalent compounds.

Hereinafter, polyvalent carboxylic acid and a polyol that form polyester are sequentially described in detail.

(i) Polyvalent Carboxylic Acid

The polyester may include a cyclic structure in the repeating unit derived from polyvalent carboxylic acid and may include a cyclic structure in the repeating unit derived from a polyol. As polyvalent carboxylic acid having a cyclic structure, aromatic polyvalent carboxylic acid is preferable, and aromatic dicarboxylic acid is more preferable.

Examples of aromatic dicarboxylic acid include phthalic acid, terephthalic acid, and isophthalic acid. Among these, in view of further improving hardness, phthalic acid and terephthalic acid are preferable, and phthalic acid is more preferable.

In polyester, in view of high hardness, it is preferable to increase a ratio of phthalic acid in polyvalent carboxylic acid, a ratio of the repeating unit derived from phthalic acid is preferably 70 mol % or greater, more preferably 80 mol % or greater, and even more preferably 90 mol % or greater in the repeating unit derived from polyvalent carboxylic acid included in polyester. According to an aspect, phthalic acid and terephthalic acid can be used together.

As polyvalent carboxylic acid, aliphatic polyvalent carboxylic acid and aromatic polyvalent carboxylic acid can be used together. Specific examples of aliphatic polyvalent carboxylic acid include aliphatic dicarboxylic acid such as oxalic acid, malonic acid, succinic acid, maleic acid, fumaric acid, glutaric acid, adipic acid, suberic acid, azelaic acid, cyclohexanedicarboxylic acid, and sebacic acid. Among these, succinic acid and adipic acid are preferable, and adipic acid is particularly preferable. As an aspect of a combination of aliphatic polyvalent carboxylic acid and aromatic polyvalent carboxylic acid, a combination of adipic acid and phthalic acid, a combination of adipic acid and terephthalic acid, a combination of succinic acid and phthalic acid, and a combination of succinic acid and terephthalic acid are exemplified.

In view of higher hardness of the cellulose acylate film, in the polyester, when the number of repeating units (molar ratio) derived from aliphatic polyvalent carboxylic acid is m, the number of repeating units (molar ratio) derived from aromatic polyvalent carboxylic acid is n, a ratio m:n between m and n is preferably in a range of 0:10 to 3:7 and more preferably in a range of 0:10 to 2:8.

In view of compatibility with cellulose acylate, as polyvalent carboxylic acid, polyvalent carboxylic acid having 4 to 10 carbon atoms is preferable, and polyvalent carboxylic acid having 4 to 8 is more preferable. In a case where two or more types of polyvalent carboxylic acid are used, average number of carbon atoms of the two or more types of polyvalent carboxylic acid is preferably in the range described above. If polyester having compatibility with cellulose acylate is used, bleeding-out of polyester at the time of forming a film or heating or stretching a film can be suppressed.

(ii) Polyol

A polyol that is polycondensated with polyvalent carboxylic acid described above to form polyester is not particularly limited. Examples thereof include an aliphatic polyol and an aromatic polyol, and an aliphatic polyol is preferable.

As an aliphatic polyol, aliphatic diol is preferable, and specific examples thereof include alkyldiol or alicyclic diols, and more specific examples thereof include ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 1,4-cyclohexanediol, 1,4-cyclohexanedimethanol, 2,2,4-trimethyl-1,3-pentanediol, 2-ethyl-1,3-hexanediol, 2-methyl-1,8-octanediol, 1,9-nonanediol, 1,10-decanediol, and diethylene glycol.

Examples of preferable aliphatic diol include ethylene glycol, 1,2-propanediol, and 1,3-propanediol. Ethylene glycol and 1,2-propanediol are more preferable. In view of compatibility with cellulose, ethylene glycol is particularly preferable. In a case where two types thereof are used, it is preferable to use ethylene glycol and 1,2-propanediol.

In view of compatibility with cellulose acylate, the number of carbon atoms of a polyol is preferably in a range of 2 to 10, more preferably in a range of 2 to 6, and even more preferably in a range of 2 to 4. In a case where two or more types of polyols are used, it is preferable that an average number of carbon atoms of the two or more types of polyols is in the range described above. When the number of repeating units (molar ratio) derived from polyvalent carboxylic acid is A, the number of repeating units (molar ratio) derived from polyols and preferably the number of repeating units derived from aliphatic polyols is B, in a case where a total number of repeating units (A+B) is 1.00, a ratio of A is preferably in a range of 0.50 to 0.70 and more preferably in a range of 0.50 to 0.60.

(iii) Other Components

Both terminals of the polyester may be sealed or may not be sealed. In a case where both terminals are sealed, it is difficult that a state in a normal temperature becomes a solid shape, and thus handling becomes satisfactory. In view of improving humidity stability or durability of the cellulose acylate film, it is preferable that both terminals are sealed. In a case where both terminals are sealed, it is preferable that terminals are sealed with hydrophobic functional groups (preferably an alkyl group or an aromatic group). This is because hydrolysis of ester group can be suppressed.

According to an aspect, in view of improving durability, terminals of polyester can be protected with monoalcohol residues or monocarboxylic acid residues so that terminals of polyester do not become carboxylic acid or hydroxyl group. In view of durability, a hydroxylic number of polyester is preferably 10 mgKOH/g or less, more preferably 5 mgKOH/g or less, and particularly preferably 0 mgKOH/g.

In a case where both terminals of polyester are sealed, it is preferable to seal the terminals by causing the terminals to react with monocarboxylic acid. Both terminals of polyester that are sealed in this manner become monocarboxylic acid residues. Here, the residue is a partial structure of polyester and represents a partial structure having characteristics of monomer that forms polyester. For example, a monocarboxylic acid residue formed with monocarboxylic acid R—COOH (R is, for example, a hydrogen atom or an alkyl group.) is R—CO—. A monocarboxylic acid residue is preferably an aliphatic monocarboxylic acid residue, more preferably an aliphatic monocarboxylic acid residue having 2 to 22 carbon atoms, even more preferably an aliphatic monocarboxylic acid residue having 2 to 3 carbon atoms, and particularly preferably an aliphatic monocarboxylic acid residue having 2 carbon atoms. More specifically, examples of aliphatic monocarboxylic acid preferably include acetic acid, propionic acid, and butanoic acid, and derivatives thereof, more preferably acetic acid and propionic acid, and even more preferably acetic acid (that is, terminals of polyester are acetyl groups). As the monocarboxylic acid used in the sealing, other types of monocarboxylic acid may be used.

(iv) Average Molecular Weight

In view of low volatilization, a molecular weight of polyester is preferably 600 or greater as number-average molecular weight (Mn). Meanwhile, in view of compatibility with cellulose acylate, the number-average molecular weight is preferably 2,000 or less, more preferably 1,500 or less, and even more preferably 1,200 or less.

A number-average molecular weight and a weight-average molecular weight according to the invention are a value in terms of polystyrene that is measured by gel permeation chromatography (GPC). A specific example of the measured condition includes a measuring condition below. A number-average molecular weight (Mn) indicated by examples below is a value that is measured in the condition below.

GPC device: HLC-8120 (manufactured by Tosoh Corporation):

Column: TSK gel Multipore HXL-M (manufactured by Tosoh Corporation, 7.8 mm ID (inner diameter)×30.0 cm)

Eluent: Tetrahydrofuran (THF)

(v) Content

In view of higher hardness, the content of polyester included in the cellulose acylate film is preferably 5 to 25 parts by mass, more preferably 5 to 20 parts by mass, and even more preferably 5 to 15 parts by mass with respect to 100 parts by mass of cellulose acylate.

Polyester described above can be synthesized by the well-known method, and can be obtained as commercially available products. Examples of the synthesis method include well-known methods such as a dehydration condensation reaction between dicarboxylic acid and diol and addition of dicarboxylic anhydride to glycol and dehydration condensation reaction, but the invention is not limited thereto.

(Components Included in Cellulose Acylate Film)

The cellulose acylate film at least includes cellulose acylate and polyester described above. In a range of not deteriorating the effect of the invention, the cellulose acylate film may include one or more additives well-known as additives of the cellulose acylate film. Examples of the additive include a plasticizer such as a phosphoric acid ester-based plasticizer, a carboxylic ester-based plasticizer, and a polycondensation oligomeric plasticizer, a polarizing sheet durability improving agent, a ultraviolet absorbing agent, a retardation humidity durability improving agent, and an antioxidant.

(Method for Manufacturing Cellulose Acylate Film)

The cellulose acylate film can be manufactured by well-known methods. Manufacturing methods thereof are not particularly limited. Specific examples of the method for manufacturing a film include a solution casting film forming method or a melt film forming method. As details of the manufacturing method, paragraphs 0056 to 0083 of JP2012-215812A can be exemplified. The cellulose acylate film may be a single layer film or may have a structure of laminating two or more layers. For example, cellulose acylate film may have a laminate structure consisting of two or more layers of a core layer and an outer layer (may be called a surface layer or a skin layer) and is also preferably a laminate structure consisting of three layers of an outer layer, a core layer, and an outer layer, and a form in which films having these laminate structures are formed by co-casting is also preferable. The cellulose acylate film having a laminate structure preferably contains the polyester in the respective laminated layers.

In a case where the cellulose acylate film has a laminate structure of two or more layers, it is preferable to further add a matting agent to an outer layer. For example, as the matting agent, matting agents disclosed in JP2011-127045A can be used. For example, silica particles having an average particle diameter of 20 nm can be used. The cellulose acylate film can include well-known additives in addition to the cellulose acylate and the polyester that are essential components. As the additives, paragraphs 0022 to 0055 of JP2012-215812A can be exemplified. Polarizing sheet durability improving agents disclosed in paragraphs 0053 to 0122 of JP2013-174861A can be used as an additive.

(Thickness of Cellulose Acylate Film)

The thickness of the cellulose acylate film is not particularly limited, as long as the thickness is determined according to a use of the optical film including this film. Recently, thickness reduction of an image display device such as LCD is progressed. Therefore, it is preferable to reduce a thickness of an optical film that is integrated into a device. In this point of view, a film thickness of a cellulose acylate film is preferably 40 μm or less and more preferably 30 μm or less. Meanwhile, in view of handleability of the film, a film thickness of the cellulose acylate film is preferably 10 μm or greater, more preferably 15 μm or greater, and even more preferably 20 μm or greater. In the case of a cellulose acylate film having a laminate structure, the film thickness thereof refers to a total film thickness of plural layers.

<Hardened Layer>

An optical film according to an aspect of the invention has a hardened layer formed by hardening a curable composition on at least one surface of the cellulose acylate film directly or indirectly via another layer. This hardened layer can contribute to improving of the durability of the optical film, as a hard coat layer. In view of improving scratch resistance of a film, the hardened layer is preferably positioned on an outermost layer of the optical film.

The curable composition for forming a hardened layer includes a granular filler, polyester urethane having a tensile strength of 25 MPa or greater and a tensile elongation of 200% or greater, and a curable compound. Hereinafter, details of the respective components are sequentially described.

(Granular Filler)

It is possible to improve hardness of the hardened layer by causing the hardened layer to include a granular filler. Accordingly, it is possible to cause the optical film including the hardened layer to have high hardness. If the content of the granular filler included in the hardened layer is 15 parts by mass or greater with respect to 100 parts by mass of a total amount of a solid content of the curable composition for forming the hardened layer, it is possible to obtain a hardened layer having high hardness. If the content of the granular filler is 60 parts by mass or less, it is possible to suppress the increase of haze caused by falling of a granular filler in a manufacturing step. Therefore, the content of the granular filler is set to 15 to 60 parts by mass with respect to 100 parts by mass of a total amount of a solid content of a curable composition. A content of the curable composition with respect to 100 parts by mass of a total amount of a solid content has the same meaning as the content in the hardened layer formed with this composition.

In view of further improving hardness of hardened layer, the content of the granular filler is preferably 20 parts by mass or greater. In view of further reducing haze, the content of the granular filler is preferably 50 parts by mass or less.

As an aspect of the granular filler, inorganic particles are exemplified. Otherwise, as another aspect thereof, reactive inorganic particles obtained by surface-modifying inorganic particles with an organic functional group can be exemplified. In any aspects, it is preferable that the granular filler is colloid particles, in view of suppressing unintended aggregation in the curable composition and the hardened layer.

Examples of the inorganic particles include silica, particles of metal oxide such as aluminum oxide, zirconia, titania, zinc oxide, germanium oxide, indium oxide, tin oxide, indium tin oxide (ITO), antimony oxide, and cerium oxide, and particles of metal fluoride such as magnesium fluoride and sodium fluoride. Metal particles, metal sulfide particles, metal nitride particles and the like may be used. Since hardness is high and the hardened layer is less colored, silica and aluminum oxide are preferable. It is possible to give an anti-reflection function to the optical film, by laminating a hardened layer and a layer having a different refractive index from that of this hardened layer. In order to cause the optical film to be a layer of a relatively higher refractive index than other laminated layers, particles of a higher refractive index such as zirconia, titania, and antimony oxide can be used. In order to cause the optical film to be a layer of a relatively lower refractive index, fluoride particles such as magnesium fluoride and sodium fluoride or particles of a low refractive index such as hollow silica particles can be appropriately selected to be used. In a case where it is desired to give antistatic properties (conductive properties), indium tin oxide (ITO), tin oxide, or the like can be appropriately selected to be used. These can be used singly or two or more types thereof may be used in combination.

As described above, as the granular filler, particles obtained by surface-modifying inorganic particles with an organic functional group can be used. An aspect of an organic functional group is a reactive group. Here, the “reactive group” refers to a group that can react with any one or more component included in the curable composition for forming the hardened layer. For example, examples of the reactive group include groups that react with curable compounds described below. The present inventors consider that the granular filler having a reactive group that can react with a curable compound does not suppress intermolecular crosslinking in the curable compound and thus improves hardness of a hardened layer. The reaction between a reactive group and another component can be progressed, for example, by a hardening treatment (light irradiation, heating, or the like) for hardening a curable composition. Accordingly, particles in the hardened layer generally include a reactive group in a form after reaction.

As the reactive group, a polymerizable unsaturated group is preferable, and specific examples thereof include ethylenically double bonds such as a (meth)acryloyl group, a vinyl group, and an allyl group and an epoxy group.

The granular filler may be a granular filler obtained by surface-modifying inorganic particles with a non-polymerizable organic functional group. This surface modification is effective for suppression of aggregation of particles. Specific examples of the non-polymerizable organic functional group include a trimethylsilyl group, a triethylsilyl group, a triisopropylsilyl group, and a t-butyldimethylsilyl group.

With respect to the surface-modified granular filler, a coating amount with an organic functional group is preferably 2.00×10⁻³ g/m² or greater and more preferably 3.00×10⁻³ g/m² or greater, for each unit area of surface-modified inorganic particles.

As the granular filler, polymer particles having a core/shell structure in which inorganic particles are cores and polymers are shells can be used.

The coating amount by an organic functional group or a polymer described above is generally a constant weight value of mass loss % in a case where dry powders are completely burnt in the air, and can be obtained, for example, by thermal mass analysis from the room temperature (for example, about 25° C.) to generally 800° C. in the air.

In view of further improving hardness, the average particle diameter of the granular filler is preferably 1 nm or greater and more preferably 10 nm or greater. Meanwhile, in view of obtaining a hardened layer having higher transparency, an average particle diameter of the granular filler is preferably 100 nm or less and more preferably 60 nm or less.

The shape of the granular filler is not particularly limited, and may be a spherical shape or a non-spherical shape. A particle diameter of a non-spherical granular filler refers to an average value of a major axis length and a minor axis length of a granular filler.

With respect to an average particle diameter of the granular filler, in addition to calculation of the average value by acquiring a sectional TEM picture of a hardened layer with a transmission type electron microscope (TEM) and measuring particle diameters of respective particles included in the sectional TEM picture, the granular filler is formed to a solvent dispersed sol, and the average particle diameter can be obtained as a 50% average particle diameter in this sol. For example, the 50% average particle diameter can be obtained by using Nanotrac manufactured by Nikkiso Co., Ltd. or a particle size analyzer.

The granular filler can be manufactured by well-known methods and can be obtained as a commercially available product.

(Polyester Urethane)

The hardened layer is formed from a curable composition including polyester urethane having a tensile strength of 25 MPa or greater and a tensile elongation of 200% or greater together with the granular filler and curable compound described below. The polyester urethane is a polymer including an ester bond and a urethane bond (—O—CO—NH—) in one molecule. It is considered that polyester urethane having a tensile strength of 25 MPa or greater and a tensile elongation of 200% or greater contributes to causing the hardened layer to have high hardness and giving the hardened layer appropriate flexibility. The present inventors assume that this contributes to causing the hardened layer to have high hardness and improvement of brittleness. The present inventors assume that excellent affinity of polyester urethane with particle surfaces of the granular filler contributes to suppression of decrease of transparency. More specifically, the present inventors consider that excellent affinity of polyester urethane with the particle surfaces of the granular filler contributes to suppression of the generation of factors (falling or elution of the granular filler in a chemical treatment in a manufacturing step and aggregation of the granular filler) that cause decrease of transparency.

If a content of polyester urethane is 1 part by mass or greater with respect to a total amount of a solid content of a curable composition, the above effect due to adding polyester urethane can be sufficiently obtained. If a content of polyester urethane is 10 parts by mass or less, hardness of the hardened layer can be maintained. Accordingly, the content of polyester urethane is in a range of 1 to 10 parts by mass with respect to a total amount of a solid content of a curable composition. In view of improvement of brittleness and suppression of decrease of transparency, the content thereof is more preferably 2 parts by mass or greater. In view of maintaining hardness of the hardened layer, the content thereof is more preferably 8 parts by mass or less.

The polyester urethane has a tensile strength of 25 MPa or greater and a tensile elongation of 200% or greater. The present inventors assume that, if polyester urethane exhibiting the tensile strength and the tensile elongation is used, appropriate flexibility is given to the hardened layer, and thus the polyester urethane contributes to both of high hardness and improvement of brittleness. The tensile strength is more preferably 40 MPa or greater and even more preferably 50 MPa or greater. In view of compatibilization stability in the curable composition, the tensile strength is preferably 70 MPa or less. Meanwhile, the tensile elongation is preferably 450% or greater and more preferably 600% or greater. In view of securing pencil hardness that is one of indexes of the film hardness, the tensile elongation is preferably 1,000% or less. The method for measuring the pencil hardness is described with reference to examples below. The tensile strength and the tensile elongation of polyester urethane are values measured by using a tensile strength test machine according to JIS K 6251. With respect to an example of a specific measuring method, examples below can be exemplified.

Polyester urethane can be obtained by polymerization of a monomer component at least including diol, dicarboxylic acid, and diisocyanate. As these three types of monomers, monomers respectively having hydroxyl groups (—OH), carboxyl groups (—COOH), and isocyanate groups (—NCO) at both terminals of hydrocarbon groups having an unbranched structure are preferable.

The hydrocarbon group having an unbranched structure is preferably an alkylene group, an alkenylene group, an alkynylene group, and an arylene group, or a combination thereof.

An alkylene group, an alkenylene group, and an alkynylene group preferably have linear structures.

The number of carbon atoms in a case where the hydrocarbon group is an alkylene group, an alkenylene group, and an alkynylene group is preferably 1 to 8, more preferably 2 to 6, and even more preferably 2 to 4.

An arylene group may have an alkyl group having 1 to 8 carbon atoms as a substituent.

An arylene group is preferably a phenylene group or a naphthylene group, more preferably a phenylene group, and even more preferably a p-phenylene group.

As the hydrocarbon group, the alkylene group, and the arylene group, or a combination thereof is particularly preferable.

As diol used as a monomer of polyester urethane, ethylene glycol, 1,3-propanediol, 1,4-butanediol, neopentyl glycol, 1,6-hexanediol, 1,4-cyclohexanedimethanol, and 1,5-pentanediol are preferable.

As dicarboxylic acid, terephthalic acid, isophthalic acid, naphthalene dicarboxylic acid, 1,4-cyclohexanedicarboxylic acid, succinic acid, glutaric acid, adipic acid, oxalic acid, and malonic acid are preferable.

As diisocyanate, ethylene diisocyanate, trimethylene diisocyanate, tetramethylene diisocyanate, hexamethylene diisocyanate, m-xylylene diisocyanate, p-phenylene diisocyanate, tolylene diisocyanate, p,p′-diphenylmethane diisocyanate, and 1,5-naphthylene diisocyanate are preferable.

In view of affinity with the granular filler, a number-average molecular weight (Mn) of polyester urethane is preferably 5,000 or greater and more preferably 10,000 or greater. In view of compatibility with the curable compound, a number-average molecular weight is preferably 50,000 or less.

According to an aspect, polyester urethane may have a reactive group. As the reactive group, a polymerizable unsaturated group is preferable. Specific examples are as described above with respect to the reactive groups that the granular filler may have.

As the polyester urethane described above, polyester urethane synthesized by the well-known methods may be used or commercially available products may be used. The commercially available products include VYLON (registered trademark) series (product name): manufactured by Toyobo Co., Ltd., and VYLON UR-2300, VYLON UR-3200, VYLON UR-3210, VYLON UR-3260, VYLON UR-5537, 300 VYLON UR-8300, and VYLON UR-8700 are preferably used.

(Curable Compound)

As the curable compound, various compounds having polymerizable groups that can be hardened (polymerized) by a hardening treatment can be used. Examples of the polymerizable group include a polymerizable group that can be polymerized and reacted by irradiation of light, electron beams, and radioactive rays, a polymerizable group that can be polymerized and reacted by heat, and a photopolymerizable group is preferable. The curable compound includes a monomer, an oligomer, a prepolymer, and the like.

Specific examples of the polymerizable group include a polymerizable unsaturated group such as a (meth)acryloyl group, a vinyl group, a styryl group, and an allyl group or a ring-opening polymerization-type polymerizable group such as an epoxy group. Among these, in view of curing properties or the like, a (meth)acryloyl group is preferable.

Specific examples of the curable compound included in the curable composition include compounds below: (meth)acrylic acid diesters of alkylene glycol such as neopentyl glycol acrylate, 1,6-hexanediol (meth)acrylate, and propylene glycol di(meth)acrylate; (meth)acrylic acid diesters of polyoxyalkylene glycol such as triethylene glycol di(meth)acrylate, dipropylene glycol di(meth)acrylate, polyethylene glycol di(meth)acrylate, and polypropylene glycol di(meth)acrylate; (meth)acrylic acid diesters of polyhydric alcohol such as pentaerythritol di(meth)acrylate; (meth)acrylic acid diesters of ethylene oxide or propylene oxide adducts such as 2,2-bis{4-(acryloxy.diethoxy)phenyl}propane or 2,2-bis {4-(acryloxy.polypropoxy)phenyl}propane; and urethane (meth)acrylates;

polyester (meth)acrylates; isocyanuric acid acrylates; and epoxy (meth)acrylates.

Among these, esters of polyhydric alcohol and (meth)acrylic acid are preferable, and a polyfunctional monomer having three or more (meth)acryloyl groups in one molecule is more preferable.

Specific examples thereof include (di)pentaerythritol tri(meth)acrylate, (di)pentaerythritol tetra(meth)acrylate, (di)pentaerythritol penta(meth)acrylate, (di)pentaerythritol hexa(meth)acrylate, tripentaerythritol triacrylate, tripentaerythritol hexatriacrylate, trimethylolpropane tri(meth)acrylate, trimethylolethane tri(meth)acrylate, ditrimethylolpropane tetra(meth)acrylate, EO-modified trimethylolpropane tri(meth)acrylate, PO-modified trimethylolpropane tri(meth)acrylate, EO-modified phosphoric acid tri(meth)acrylate, 1,2,4-cyclohexane tetra(meth)acrylate, pentaglycerol triacrylate, 1,2,3-cyclohexane tetramethacrylate, polyester polyacrylate, and caprolactone-modified tris(acryloxyethyl) isocyanurate.

According to the invention and the specification, the expression “(meth)acryloyl group” is used as a meaning including an acryloyl group and a methacryloyl group. The expression “(meth)acrylate” is used as a meaning including acrylate and methacrylate. The expression “(meth)acrylic acid” is used as a meaning including acrylic acid and methacrylic acid. The expression “(di)penta” is used as a meaning including penta and dipenta.

A resin (an oligomer or a prepolymer) having three or more (meth)acryloyl groups, polyfunctional (meth)acrylate having three or more (meth)acryloyl groups, and urethane(meth)acrylate are also preferable.

Examples of the resin (an oligomer or a prepolymer) having three or more (meth)acryloyl groups include oligomers or prepolymers of polyfunctional compounds such as a polyester resin, a polyether resin, an acrylic resin, an epoxy resin, an urethane resin, an alkyd resin, a spiroacctal resin, a polybutadiene resin, a polythiol polyene resin, and a polyhydric alcohol.

Specific examples of polyfunctional (meth)acrylate having three or more (meth)acryloyl groups include example compounds disclosed in paragraph 0096 of JP2007-256844A.

Examples of the urethane(meth)acrylate include urethane(meth)acrylate that can be obtained by reacting alcohol, a polyol, and/or a compound containing a hydroxyl group such as acrylate containing a hydroxyl group with isocyanate and esterifying polyurethane compound obtained by this reaction with (meth)acrylic acid, if necessary. Specific examples thereof include various commercially available products disclosed in paragraphs 0017 of JP2007-256844A.

In view of reduction of hardening shrinkage, the curable composition can include an epoxy-based compound having an epoxy group as a polymerizable group, as the curable compound. As the epoxy-based compound, a polyfunctional epoxy-based compound including two or more epoxy groups in one molecule is preferable. Specific examples thereof include epoxy-based compounds disclosed in JP2004-264563A, JP2004-264564A, JP2005-37737A, JP2005-37738A, JP2005-140862A, JP2005-140862A, JP2005-140863A, and JP2002-322430A. It is preferable to use a compound having both of an epoxy group such as glycidyl (meth)acrylate and an acrylic polymerizable group is preferable.

In view of hardness of the hardened layer, the content of the curable compound is preferably 30 parts by mass or greater, more preferably 40 parts by mass or greater, and even more preferably 50 parts by mass or greater with respect to a total amount of the solid content of the curable composition. In view of curling suppression of the film, the content thereof is preferably 84 parts by mass or less and more preferably 75 parts by mass or less.

(Components that May be Included in Curable Composition)

The curable composition can further arbitrarily include one or more well-known additives such as a polymerization initiator or a leveling agent, if necessary. As such additives, various additives that are generally used in the forming of the hard coat layer can be used. The adding amount of the additive to the curable composition may be appropriately adjusted, and is not particularly limited.

(Forming of Hardened Layer and Film Thickness)

The hardened layer can be formed by applying the curable composition on the cellulose acylate film surface directly or indirectly via another layer and performing a hardening treatment. The hardening treatment can be performed by light irradiation, heating, or the like, according to the types of the curable compound included in the curable composition. The hardening condition may be appropriately determined according to the formation of the curable composition. In view of high hardness of the optical film, the film thickness of the hardened layer formed in this manner is preferably 1 μm or greater and more preferably 2 μm or greater. Meanwhile, in view of thinning the optical film, the film thickness thereof is preferably 20 μm or less, more preferably 15 μm or less, and even more preferably 10 μm or less.

<Layer that May be Included in Optical Film>

The optical film according to an aspect of the invention includes the cellulose acylate film and the hardened layer provided on one or both sides of this film, but may further include one or more other layers at arbitrary positions. Examples of these layers include a layer having a different refractive index from that of the hardened layer. If this layer is laminated, the optical film may have a function as an anti-reflection film. The refractive index according to the invention refers to a refractive index to light having a wavelength of 589 nm. The refractive index refers to a refractive index at a measurement wavelength of 589 nm directly measured by an Abbe's refractometer. However, the refractive index can be quantitatively evaluated by measuring a spectral reflection spectrum or spectral ellipsometry.

The refractive index of the hardened layer is not particularly limited. According to an aspect, the hardened layer and the layer having a different refractive index are included in the optical film, using the hardened layer as a layer of a high refractive index and the layer having a different refractive index as a layer of a low refractive index. According to another aspect, the hardened layer and the layer having a different refractive index may be used in a reversed manner. The hardened layer may be a layer of an intermediate refractive index described below.

The refractive index of the layer of a low refractive index is, for example, in a range of 1.20 to 1.46. Meanwhile, the refractive index of the layer of a high refractive index is, for example, in a range of 1.65 to 2.20. According to an aspect, the hardened layer can be caused to be the layer of a high refractive index exhibiting a refractive index in the range described above. The refractive index of the hardened layer can be controlled by the types and the content of a granular filler described above, the types and the content of the curable compound, or the like.

The layer of a low refractive index can be, for example, a vapor deposition layer of an inorganic material, but the invention is not limited thereto. As details of the layer of a low refractive index, paragraphs 0111 and 0112 of JP2011-136503A can be exemplified.

In addition to the layer of a high refractive index and the layer of a low refractive index, a layer of an intermediate refractive index that has an intermediate refractive layer of these refractive indexes may be included in the optical film. As details of the layer of an intermediate refractive index, paragraphs 0109 and 0110 of JP2011-136503A can be exemplified.

<Film Thickness and Physical Properties of Optical Film>

With respect to the optical film according to an aspect of the invention, a total thickness of the film including the cellulose acylate film, the hardened layer, and an arbitrary additional layer may be, for example, in a range of 25 μm to 100 μm. In view of thickness reduction of the image display device into which the optical film is integrated, a total thickness of the optical film is preferably 70 μm or less and even more preferably 50 μm or less.

The optical film can be caused to have extremely high hardness by respectively causing the cellulose acylate film and the hardened layer to have high hardness. If Knoop hardness measured by a method regulated in JIS Z 2251:1998 is used as an index of hardness of the optical film, the optical film can have high hardness exhibiting Knoop hardness of 280 N/mm² or greater, as Knoop hardness measured on the surface on a side of having the hardened layer. The hardened layer can be preferably positioned as the outermost layer of the optical film, and in this case, the surface exhibiting the Knoop hardness is the hardened layer surface. The Knoop hardness is more preferably 300 N/mm² or greater. As the Knoop hardness is higher, the Knoop hardness is preferable in view of scratch resistance improvement. The Knoop hardness is, for example, 500 N/mm² or less or 400 N/mm² or less. However, as described above, as the Knoop hardness is higher, the Knoop hardness is more preferable, and thus the upper limit is not particularly limited. Specifically, the Knoop hardness of the optical film can be measured in a method described in the examples below.

[Polarizing Plate]

Another aspect of the invention relates to a polarizing plate including the optical film and a polarizer. The optical film according to an aspect of the invention can function as a polarizing plate protective film. Accordingly, it is possible to provide a polarizing plate having excellent durability.

In the polarizing plate, the polarizer is generally disposed between two protective films. The optical film according to an aspect of the invention can be at least one or both of the two protective film. In the liquid crystal display device, two polarizing plates (visible side polarizing plates, polarizing plates on a backlight side) are generally arranged with the liquid crystal cell interposed therebetween. The polarizing plate according to an aspect of the invention may be used in any of the two polarizing plates. According to an aspect, the polarizing plate may be used in a polarizing plate on the visible side. With respect to the two protective films included in the polarizing plate on the visible side, one is disposed on the visible side and the other is disposed on a liquid crystal cell side. In this case, the optical film according to an aspect of the invention may be used in any of the protective film on the visible side and the protective film on the liquid crystal cell side. According to an aspect, the optical film is used as the protective film on the visible side.

At the time of bonding the optical film (protective film) and the polarizer together, in order to improve adhesiveness, saponification of the film for improving adhesiveness is generally performed. Meanwhile, the optical film having the hard coat layer including the granular filler has a problem in that the granular filler falls off the hard coat layer in the saponification treatment, haze of the hard coat layer increases, haze of the optical film increases accordingly, and thus transparency decreases. In contrast, as described above, in the optical film according to an aspect of the invention, the formulation is adjusted so as to prevent falling of the granular filler, and thus it is possible to suppress or prevent the falling of the granular filler in the saponification treatment. Therefore, it is possible to exhibit high transparency even after the saponification treatment. The saponification treatment can be performed in well-known methods. As details thereof, for example, paragraph 0114 of JP2011-136503A can be exemplified. In the bonding of the optical film and the polarizer, an adhesive layer formed from the well-known adhesives such as polyvinyl alcohol can be used, if necessary.

As the polarizer included in the polarizing plate, a film obtained by immersing a polyvinyl alcohol film in an iodine solution and stretching the polyvinyl alcohol film can be used. As details of the polarizer, paragraph 0117 of JP2011-136503A can be exemplified.

According to an aspect, one of the two protective films included in the polarizing plate may be the optical film, and the other may be an optical compensation film. As the optical compensation film, a well-known film can be used.

[Image Display Device]

Another aspect of the invention relates to an image display device including the optical film.

Examples of the image display device include various image display devices such as a liquid crystal display device (LCD), a plasma display panel (PDP), an electroluminescent display (ELD), and a cathode ray display device (CRT).

According to an aspect, the optical film may be a protective film disposed on an outer side of a display surface of the image display device. In this case, an outermost layer on the outer side of the display surface is preferably the hardened layer included in the optical film, in view of further improvement of the scratch resistance of the image display device.

According to an aspect, the image display device may be a liquid crystal display device including a polarizing plate as an essential component. In this case, the optical film is preferably included as the protective film of the polarizing plate. Details of the polarizing plate are as described above.

The liquid crystal cell of the liquid crystal display device may be a liquid crystal cell for various driving modes such as a twisted nematic (TN) mode, a vertical alignment (VA) mode, an optically compensated bend (OCB) mode, an in-plane switching (IPS) mode, and an electrically controlled birefringence (ECB) mode.

As described above, according to the invention, it is possible to provide a high hardness optical film in which increase of the haze is suppressed. Accordingly, it is possible to provide an image display device having satisfactory visibility of the image and excellent scratch resistance.

### Examples

Hereinafter, the invention is described in greater detail based on the examples below. Materials, use amounts, ratios, treatment details, an order of treatments, and the like described in examples below can be appropriately changed without departing from the gist of the invention. Accordingly, the scope of the invention should not be construed in a manner of being limited by the specific examples below.

1. Manufacturing of Cellulose Acylate Film

<Manufacturing of Cellulose Acylate Film K1>

(Manufacturing of Cellulose Acylate Dope for Core Layer)

Compositions below were introduced to a mixing tank and stirred, respective components were dissolved, and a cellulose acetate solution was prepared.

| | |
|---|---|
| Cellulose acetate having an acetyl substitution degree | 100 parts by mass |
| of 2.88 | |
| Polyester KP1 (see Table 1) having a cyclic structure | 10 parts by mass |
| Polarizing sheet durability improving agent | 4 parts by mass |
| (compound in a structure formula below) | |
| Ultraviolet absorbing agent (compound in a structure | 2 parts by mass |
| formula below) | |
| Methylene chloride (first solvent) | 430 parts by mass |
| Methanol (second solvent) | 64 parts by mass |

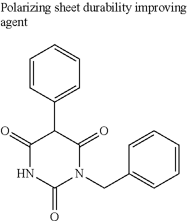 [SMILES: O=C1NC(=O)N(Cc2ccccc2)C(=O)C1c1ccccc1]

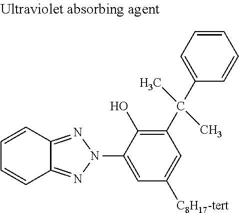

(Manufacturing of Cellulose Acylate Dope for Outer Layer)

10 parts by mass of a matting agent solution below was added to 90 parts by mass of cellulose acylate dope for a core layer, so as to prepare a cellulose acetate solution for an outer layer.

| | |
|---|---|
| Silica particle having an average particle | 2 parts by mass |
| diameter of 20 nm (AEROSIL (registered trademark) | |
| R972, manufactured by Nippon Aerosil Co., Ltd.) | |
| Methylene chloride (first solvent) | 76 parts by mass |
| Methanol (second solvent) | 11 parts by mass |
| Cellulose acylate dope for core layer | 1 part by mass |

(Manufacturing of Cellulose Acylate Film)

Cellulose acylate dope for a core layer and a cellulose acylate dope for an outer layer on both sides thereof were casted from a casting opening onto a drum at 20° C. so as to form three layers at the same time. The film was stripped in a state in which a solvent content was about 20 mass %, both ends of the film in a width direction were fixed with tenter clips, and was dried while being stretched by 1.1 times in a width direction in a state in which a residual solvent was 3 to 15 mass %. Thereafter, a cellulose acylate film having a thickness of 20 μm was manufactured by transporting the film between rollers of a thermal treatment device, so as to manufacture the cellulose acylate film K1. All of the respective outer layers of the cellulose acylate film K1 were formed to be 2 μm and the thickness of the entire film was adjusted by adjusting the thickness of the core layer.

<Manufacturing of Cellulose Acylate Film K2>

In the manufacturing of the cellulose acylate film K1, a cellulose acylate film K2 was manufactured in the same manner except for changing polyester having a cyclic structure to KP2 shown in Table 1.

<Manufacturing of Cellulose Acylate Film K3>

In the manufacturing of the cellulose acylate film K1, the cellulose acylate film K3 was manufactured in the same manner except for changing polyester having a cyclic structure to KP3 shown in Table 1.

TABLE 1

| | Polyvalent carboxylic acid | | | | | | |
|---|---|---|---|---|---|---|---|
| | mixture ratio (molar ratio) | | | Polyol | | | Number-average |
| Polyester having a | Adipic | Phthalic | Terephthalic | | Mixture ratio | | molecular |
| cyclic structure | acid | acid | acid | Type | (molar ratio) | Terminal | weight |
| KP1 | 0.15 | 0.35 | 0 | Ethylene glycol | 0.50 | Acetyl group | 1,000 |
| KP2 | 0 | 0.50 | 0 | Ethylene glycol | 0.50 | Acetyl group | 1,000 |
| KP3 | 0 | 0 | 0.50 | Ethylene glycol | 0.50 | Acetyl group | 1,000 |

<Manufacturing of Cellulose Acylate Film K4>

In the manufacturing of the cellulose acylate film K1, a cellulose acylate film K4 was manufactured in the same manner except for causing the film thickness to be 40 μm.

<Manufacturing of Cellulose Acylate Film K5>

In the manufacturing of the cellulose acylate film K1, a cellulose acylate film K5 was manufactured in the same manner except for using triphenyl phosphate instead of the polyester KP1 having a cyclic structure.

2. Manufacturing of Coating Liquid for Forming Hardened Layer (Curable Composition)

Components below were mixed so as to prepare a coating liquid for forming the hardened layer.

| | |
|---|---|
| Curable compound A1 | 12.7 parts by mass |
| Curable compound A2 | 12.7 parts by mass |
| Polymerization initiator 1 | 1.1 parts by mass |
| Polyester urethane P-1 | 6.3 parts by mass |
| Organo silica sol X1 | 9.5 parts by mass |
| Organo silica sol | 19.0 parts by mass |
| Additive F | 0.04 parts by mass |
| Methyl ethyl ketone | 18.3 parts by mass |
| Methyl isobutyl ketone | 15.2 parts by mass |

Details of the component are described as below.

Curable compound A1: Dipentaerythritol hexaacrylate (Product name: DPHA manufactured by Nippon Kayaku Co., Ltd.)

Curable compound A2: Pentaerythritol tetraacrylate (Product name: A-TMMT manufactured by Shin-Nakamura Chemical Co., Ltd.)

Polymerization initiator 1: Product name: IRGACURE (registered trademark) 184 manufactured by BASF SE

Polyester urethane P-1: 30 mass % methyl ethyl ketone (MEK) solution of polyester urethane (Product name: VYLON (registered trademark) UR-3260 manufactured by Toyobo Co., Ltd.)

Silica organo sol X1: Coloidal silica dispersion liquid having an average particle diameter of about 15 nm (solid content: 40 mass %, MEK sol liquid of silica colloid particles having methacryloyl group on particle surfaces, Product name: MEK-AC-2140Y manufactured by Nissan Chemical Industries, Ltd.)

Silica organo sol X2: Coloidal silica dispersion liquid having an average particle diameter of about 15 nm (Solid content: 30 mass %, methyl isobutyl ketone (MIBK) sol liquid of silica colloid particles having a methacryloyl group on the particle surfaces, Product name: MIBK-SD manufactured by Nissan Chemical Industries, Ltd.)

Additive F: Fluorine-containing leveling agent (Product name: MEGAFACE F-477 manufactured by DIC Corporation)

Contents of the respective components with respect to 100 parts by mass of the total amount (mass excluding the solvent from the total amount of the composition) of the solid content of the coating liquid for forming the hardened layer were as shown in Table 2 below.

TABLE 2

| Components | Content | |
|---|---|---|
| Curable compound A1 + Curable compound A2 | 67 | parts by mass |
| Polymerization initiator 1 | 3 | parts |
| Polyester urethane P-1 | 5 | parts |
| Silica colloid particles in Silica organo sol | 25 | parts |
| X1 + Silica colloid particles in Silica | | |
| organo sol X2 | | |
| Additive F | 0.04 | parts |

3. Manufacturing of Optical Film

(Manufacturing of Optical Film 101)

A coating liquid for forming the hardened layer having the formulation above was applied to the cellulose acylate film K1 by using a gravure coater. The coating liquid was dried at 80° C., nitrogen purge was performed so as to be an atmosphere in which an oxygen concentration became 1.0 volume % or less, a coated layer was formed by using an air cooling metal halide lamp (manufactured by Eye Graphics Co., Ltd.) of 160 W/cm, and the coated layer was hardened by applying ultraviolet rays having illuminance of 400 mW/cm² and an irradiation amount of 300 mJ/cm², so as to manufacture the optical film 101 having a thickness of 7 μm.

(Manufacturing of Optical Films 102 to 105)

In the method for manufacturing the optical film 101, optical films 102 to 105 were manufactured in the same manner except for changing the adding amount of the silica organo sol to the coating liquid for forming the hardened layer.

(Manufacturing of Optical Films 106 to 118)

In the method for manufacturing the optical film 101, optical films 106 to 117 were manufactured in the same manner, except for changing the adding amounts, the types, or the adding amounts and the types of polyester urethane that is added to the coating liquid for forming the hardened layer as shown in Table 3.

Polyester urethane P-2 to P-7 used were as below.

Polyester urethane P-2: Product name: VYLON UR-5537 (30 mass % MEK/toluene solution of polyester urethane) manufactured by Toyobo Co., Ltd.

Polyester urethane P-3: Product name: VYLON UR-8300 (30 mass % MEK/toluene solution of polyester urethane) manufactured by Toyobo Co., Ltd.

Polyester urethane P-4: Product name: VYLON UR-2300 (30 mass % MEK/toluene solution of polyester urethane) manufactured by Toyobo Co., Ltd.

Polyester urethane P-5: Product name: VYLON UR-3200 (30 mass % MEK/toluene solution of polyester urethane) manufactured by Toyobo Co., Ltd.

Polyester urethane P-6: Product name: VYLON UR-8700 (30 mass % MEK/toluene/cyclohexanone solution of polyester urethane) manufactured by Toyobo Co., Ltd.

Polyester urethane P-7: Product name: TESLAC 2300 (no solvent) manufactured by Hitachi Chemical Co., Ltd.

(Manufacturing of Optical Films 119 to 122)

In the method for manufacturing the optical film 101 described in Example 1, optical films 118 to 121 were manufactured in the same manner except for changing the cellulose acylate film used to films shown in Table 3.

4. Measuring of a Tensile Strength and a Tensile Elongation of Polyester Urethane

According to JIS K 6251, a tensile strength and a tensile elongation of the polyester urethane P-1 to P-7 were measured in the method described below.

With respect to the respective polyester urethanes, a dumbbell-shaped specimen (No. 3) was manufactured. In conditions of temperature of 25° C. and relative humidity of 55% RH, respective dumbbell-shaped specimen (No. 3) were pulled at a speed of 500 mm/min until being broken by using a tensile test machine RTF-1210 (manufactured by A&D Company, Limited), so as to measure maximum tensile forces required for breaking the specimen. The maximum tensile forces were divided by cross-sectional areas of the specimen, so as to obtain a tensile strength.

With respect to the tensile elongation, elongation amounts of gauge lengths at the time of breaking were measured in the same conditions as the tensile strength, lengths obtained by subtracting original gauge lengths from gauge lengths at the time of being broken were divided by original gauge lengths, so as to calculate a tensile elongation.

The measuring results were shown in Table 3.

5. Evaluation of Optical Film

The manufactured optical film was evaluated in the method described below.

(Pencil Hardness)

A pencil hardness test below was performed in conformity with a method disclosed in JIS K-5600-5-4.

The optical film was air-conditioned at temperature of 25° C., relative humidity of 55% RH for two hours, pencil hardness of a surface on which the hardened layer (hard coat layer) was laminated was measured with a load of 4.9 N by using a pencil for a test regulated in JIS S-6006, so as to evaluate the pencil hardness in the evaluation standard below.

A: 5H or higher

B: 4H

C: 3H

D: 2H

(Brittleness)

Evaluation was performed as below by using a general paint test method disclosed in JIS-K-5600-5-1—a method of bending resistance (cylindrical mandrel method).

After the respective optical films were stored for 16 hours under the conditions of a temperature of 25° C., relative humidity of 55% RH, the respective optical films were wound around mandrels having different diameters (Φ), the generation states of the cracks were observed, and brittleness (cracks resistance) was evaluated with a maximum diameter of the mandrel in which cracks were not generated. As the diameter of the mandrel was smaller, the performance was more excellent. The evaluation was performed in the evaluation standards below.

A: Diameter of a mandrel of less than 4 mm

B: Diameter of a mandrel of 4 mm to 6 mm

C: Diameter of a mandrel of greater than 6 mm and 8 mm or less

D: Diameter of a mandrel of greater than 8 mm

(Film Transparency after Chemical Treatment)

The respective optical films were subjected to an immersion treatment in a sodium hydroxide aqueous solution (2.5 N (2.5 mol/1)) heated to 40° C. for two minutes, were washed with pure water at 20° C. for 30 seconds, were immersed for 30 seconds in a sulfuric acid aqueous solution (0.1 N (0.05 mol/1)) at 25° C., and were further washed with pure water at 20° C. for 30 seconds, and haze before and after the chemical treatment was measured. The measurement of the haze was performed by using a NDH-2000 haze meter (manufactured by Nippon Denshoku Industries, Co., Ltd.) under the conditions of 25° C. and relative humidity of 55% RH, in conformity with JIS K-6714.

The fact that increase of haze after the chemical treatment was smaller means that decrease of film transparency due to a chemical treatment was small. According to the evaluation standards below, film transparency after the chemical treatment was evaluated.

A: Haze after the chemical treatment was +0.1 or less of haze before the chemical treatment

B: Haze after the chemical treatment was greater than +0.1 and 0.3 or less of haze before the chemical treatment

C: Haze after the chemical treatment was greater than +0.3 and less than 0.5 of haze before the chemical treatment

D: Haze after the chemical treatment was +0.5 or greater of haze before the chemical treatment

(Knoop Hardness)

A diamond indenter was pushed into surfaces on which the hardened layers of the respective optical films were formed, under conditions of a maximum indentation load of 20 mN, an indentation load speed of 10 seconds, and a creep of five seconds by using a HM2000-type hardness meter (manufactured by Fischer Instruments K.K.), so as to obtain Knoop hardness from a relationship between the obtained maximum indentation depth and the load.

The above results are shown in Table 3.

TABLE 3

| | | | Curable composition | | |
|---|---|---|---|---|---|
| | | | Granular filler | Polyester urethane | |
| | | | Addition amount | | Addition amount |
| | | Cellulose | (per 100 parts by | | (per 100 parts by |
| | | acylate | weight of solid | | weight of solid |
| | Classification | film | content) | Type | content) |
| Optical film 101 | Example | K1 | 25 parts by mass | P-1 | 5 parts by mass |
| Optical film 102 | Comparative | K1 | 12 parts by mass | P-1 | 5 parts by mass |
| | Example | | | | |
| Optical film 103 | Example | K1 | 15 parts by mass | P-1 | 5 parts by mass |
| Optical film 104 | Example | K1 | 60 parts by mass | P-1 | 5 parts by mass |
| Optical film 105 | Comparative | K1 | 64 parts by mass | P-1 | 5 parts by mass |
| | Example | | | | |
| Optical film 106 | Comparative | K1 | 25 parts by mass | P-1 | 0.5 parts by mass |
| | Example | | | | |
| Optical film 107 | Example | K1 | 25 parts by mass | P-1 | 1 part by mass |
| Optical film 108 | Example | K1 | 25 parts by mass | P-1 | 2 parts by mass |
| Optical film 109 | Example | K1 | 25 parts by mass | P-1 | 10 parts by mass |
| Optical film 110 | Comparative | K1 | 25 parts by mass | P-1 | 12 parts by mass |
| | Example | | | | |
| Optical film 111 | Example | K1 | 25 parts by mass | P-2 | 5 parts by mass |
| Optical film 112 | Example | K1 | 25 parts by mass | P-3 | 5 parts by mass |
| Optical film 113 | Example | K1 | 25 parts by mass | P-4 | 5 parts by mass |
| Optical film 114 | Example | K1 | 25 parts by mass | P-5 | 5 parts by mass |
| Optical film 115 | Example | K1 | 25 parts by mass | P-5 | 2 parts by mass |
| Optical film 116 | Example | K1 | 25 parts by mass | P-5 | 10 parts by mass |
| Optical film 117 | Comparative | K1 | 25 parts by mass | P-6 | 5 parts by mass |
| | Example | | | | |
| Optical film 118 | Comparative | K1 | 25 parts by mass | P-7 | 5 parts by mass |
| | Example | | | | |
| Optical film 119 | Example | K2 | 25 parts by mass | P-1 | 5 parts by mass |
| Optical film 120 | Example | K3 | 25 parts by mass | P-1 | 5 parts by mass |
| Optical film 121 | Example | K4 | 25 parts by mass | P-1 | 5 parts by mass |
| Optical film 122 | Comparative | K5 | 25 parts by mass | P-1 | 5 parts by mass |
| | Example | | | | |

| | Curable composition | | | | | |
|---|---|---|---|---|---|---|
| | Polyester urethane | | | | Film | |
| | Tensile | Tensile | | | transparency | Knoop |
| | strength | elongation | Pencil | | after chemical | hardness |
| | (MPa) | (%) | strength | Brittleness | treatment | (N/mm²) |
| Optical film 101 | 26 | 470 | A | A | A | 305 |
| Optical film 102 | 26 | 470 | C | A | A | 274 |
| Optical film 103 | 26 | 470 | B | A | A | 284 |
| Optical film 104 | 26 | 470 | A | B | B | 352 |
| Optical film 105 | 26 | 470 | A | B | C | 366 |
| Optical film 106 | 26 | 470 | A | C | C | 348 |
| Optical film 107 | 26 | 470 | A | B | B | 348 |
| Optical film 108 | 26 | 470 | A | A | A | 340 |
| Optical film 109 | 26 | 470 | B | A | A | 284 |
| Optical film 110 | 26 | 470 | C | A | A | 268 |
| Optical film 111 | 27 | 200 | A | B | A | 308 |
| Optical film 112 | 40 | 500 | A | A | A | 316 |
| Optical film 113 | 50 | 600 | A | A | A | 325 |
| Optical film 114 | 65 | 700 | A | A | A | 336 |
| Optical film 115 | 65 | 700 | A | A | A | 356 |
| Optical film 116 | 65 | 700 | A | A | A | 305 |
| Optical film 117 | 8 | 1,000 | C | A | A | 265 |
| Optical film 118 | 26 | 130 | A | C | A | 307 |
| Optical film 119 | 26 | 470 | A | A | A | 311 |
| Optical film 120 | 26 | 470 | A | A | A | 329 |
| Optical film 121 | 26 | 470 | A | A | A | 317 |
| Optical film 122 | 26 | 470 | D | A | A | 228 |

6. Manufacturing of Optical Film with Layer of Low Refractive Index

(Preparation of Hollow Silica Particle Dispersion Liquid (F))

20 parts by mass of acryloyloxypropyltrimethoxysilane and 1.5 parts by mass of diisopropoxyaluminum ethyl acetate were added to and mixed with 500 parts by mass of hollow silica particle sol (isopropyl alcohol silica sol, CS60-IPA manufactured by JGC Catalysts and Chemicals Ltd., an average particle diameter of 60 nm, a shell thickness of 10 nm, a silica concentration of 20 mass %, and a refractive index of silica particles of 1.31), and 9 parts by mass of ion exchanged water was added. Reaction was performed at 60° C. for eight hours, cooling was performed to room temperature, and 1.8 parts by mass of acetylacetone was added, so as to obtain a dispersion liquid (E). Thereafter, while cyclohexanone was added to the dispersion liquid (E) such that a content of silica became substantially constant, a solvent was substituted by distillation under reduced pressure at a pressure of 30 Torr, and finally a concentration was adjusted, so as to obtain a dispersion liquid (F) having concentration of solid contents of 18.2 mass %. A residual amount of isopropyl alcohol (IPA) of the obtained dispersion liquid (F) was analyzed by gas chromatography and was 0.5 mass % or less.

(Preparation of Coating Liquid for Layer of Low Refractive Index)

Components below were mixed and dissolved in methyl ethyl ketone, so as to manufacture a coating liquid Ln1 for a layer of a low refractive index having a solid content of 5 mass %.

| | |
|---|---|
| Fluorine-containing copolymer | 28 parts by mass |
| (P-3 disclosed in JP2004-45462A, weight-average | |
| molecular weight of about 50,000) | |
| Dipentaerythritol hexaacrylate | 10 parts by mass |
| Methacryloxy-modified silicone | 4 parts by mass |
| (RMS-033 manufactured by Gelest Inc.) | |
| Polymerization initiator (IRGACURE 127 | 3 parts by mass |
| manufactured by BASF SE) | |
| Hollow silica particle dispersion liquid (F) | 55 parts by mass |

(Manufacturing of Optical Film with Layer of Low Refractive Index)

Coating liquid Ln1 for a layer of a low refractive index was applied to the hardened layer surfaces of the optical films 101, 114, and 118, was hardened by irradiation with ultraviolet rays of 600 mJ/cm², so as to form a layer of a low refractive index having a film thickness of 0.1 μm. With respect to the obtained optical film, the hardened layer was a layer of a high refractive index having a higher refractive index than a layer of a low refractive index. It was confirmed that the obtained optical film exhibits excellent anti-reflection properties. In this manner, it is possible to obtain an optical film that can function as an anti-reflection film by laminating a layer having a different refractive index. With respect to the manufactured anti-reflection film, according to the method described above, the pencil hardness, the brittleness, and the film transparency after the chemical treatment were evaluated, and it was confirmed that the results were satisfactory.

7. Manufacturing of Polarizing Plate

(Saponification Treatment of Polarizing Plate Protective Film)

The respective optical films manufactured in the examples were immersed in the 2.3 mol/of a sodium hydroxide aqueous solution at 55° C. for three minutes. Washing was performed in a water washing bathtub in room temperature, and neutralization was performed by using 0.05 mol/l of sulfuric acid at 30° C. Washing was further performed in a water washing bathtub in room temperature, and drying was performed with hot air of 100° C. In this manner, the saponification treatment of the optical film was performed.

(Manufacturing of Polarizing Plate)

Iodine was adsorbed in the stretched polyvinyl alcohol film so as to manufacture a polarizer.

The optical film subjected to the saponification treatment was bonded to one side of the polarizer, by using polyvinyl alcohol-based adhesive. The bonding was performed such that the respective cellulose acylate films of the optical films were positioned on the polarizer side (inner side), and the hardened layers were positioned on the outer side.

A saponification treatment was performed on a commercially available cellulose triacetate film (FUJITAC (registered trademark) TD80UF manufactured by Fujifilm Corporation) in the same manner, a commercially available cellulose triacetate film after a saponification treatment was bonded to a surface of the polarizer on an opposite surface to which the respective optical films manufactured above were bonded by using a polyvinyl alcohol-based adhesive.

At the same time, arrangement was performed such that a transmission axis of the polarizer and respective slow axes of the optical film were parallel to each other. The transmission axis of the polarizer and a slow axis of the commercially available cellulose triacetate film were arranged to orthogonal to each other.

Respective polarizing plates were manufactured as described above.

7. Manufacturing of Liquid Crystal Display Device

A polarizing plate of a commercially available liquid crystal television (BRAVIA (registered trademark) J5000 manufactured by SONY Corporation) on a visible side was stripped, the respective polarizing plates manufactured in “6.” above were bonded one by one on an observer side via a pressure sensitive adhesive such that the respective optical films were on the opposite side of the liquid crystal cell side, so as to obtain a liquid crystal display device.

In the manufactured liquid crystal display device, a clear image was able to be recognized.

The invention was useful in a field of manufacturing an image display device such as a liquid crystal display device.

What is claimed is:

1. An optical film comprising:
a cellulose acylate film; and
a hardened layer formed by hardening a curable composition,
wherein the cellulose acylate film includes polyester having a cyclic structure,
the curable composition at least includes a granular filler, a polyester urethane having a tensile strength of 25 MPa or greater and a tensile elongation of 200% or greater, and a curable compound, and
a content of the granular filler is in a range of 15 to 60 parts by mass and a content of the polyester urethane is in a range of 1 to 10 parts by mass, with respect to 100 parts by mass of a total amount of a solid content included in the curable composition.

2. The optical film according to claim 1,
wherein the polyester at least includes a repeating unit derived from polyvalent carboxylic acid and a repeating unit derived from a polyol, and
the repeating unit derived from polyvalent carboxylic acid at least includes a repeating unit derived from polyvalent carboxylic acid having a cyclic structure.

3. The optical film according to claim 2,
wherein the repeating unit derived from polyvalent carboxylic acid having a cyclic structure is a repeating unit derived from aromatic polyvalent carboxylic acid.

4. The optical film according to claim 3,
wherein the repeating unit derived from polyvalent carboxylic acid can include a repeating unit derived from aliphatic polyvalent carboxylic acid, and
when the number of repeating units derived from aliphatic polyvalent carboxylic acid included in the polyester is m, and the number of repeating units derived from aromatic polyvalent carboxylic acid is n, a ratio m:n between m and n is in a range of 0:10 to 3:7.

5. The optical film according to claim 1,
wherein a film thickness of the cellulose acylate film is in a range of 15 to 40 μm.

6. The optical film according to claim 1,
wherein the granular filler is a granular filler having a reactive group on an inorganic particle surface.

7. The optical film according to claim 6,
wherein the reactive group is a polymerizable unsaturated group.

8. The optical film according to claim 1,
wherein the curable compound includes a compound having a (meth)acryloyl group.

9. The optical film according to claim 1, further comprising:
a layer having a refractive index lower than that of the hardened layer.

10. The optical film according to claim 1,
wherein a Knoop hardness measured on a surface on a side having the hardened layer is 280 N/mm² or greater.

11. A polarizing plate comprising:
the optical film according to claim 1, and
a polarizer.

12. An image display device comprising:
the optical film according to claim 1.

13. An image display comprising:
the polarizing plate according to claim 1.

14. The image display device according to claim 13,
wherein the polarizing plate is at least provided on a visible side.
